(19) United States
(12) Patent Application Publication
(10) Pub. No.: US 2014/0297533 A1
(43) Pub. Date: Oct. 2, 2014

(54) SYSTEM AND METHOD OF ELECTRONIC PAYMENT USING PAYEE PROVIDED TRANSACTION IDENTIFICATION CODES

(71) Applicant: Millind Mittal, Palo Alto, CA (US)

(72) Inventor: Millind Mittal, Palo Alto, CA (US)

(21) Appl. No.: 14/302,423

(22) Filed: Jun. 12, 2014

Related U.S. Application Data
(63) Continuation-in-part of application No. 13/325,291, filed on Dec. 14, 2011.
(60) Provisional application No. 61/559,118, filed on Nov. 13, 2011.
(60) Provisional application No. 61/834,582, filed on Jun. 13, 2013.
(60) Provisional application No. 61/836,152, filed on Jun. 18, 2013.
(60) Provisional application No. 61/836,232, filed on Jun. 18, 2013.

(51) Int. Cl. G06Q 20/32; G06Q 20/38

(52) U.S. Cl. CPC G06Q 20/325; G06Q 20/385
USPC 705/44

(57) ABSTRACT

Computerized payment method using short, temporary, transaction ID (TID) symbols for secure payer (customer) financial transactions. Payees (e.g. merchants) register their unique ID telecommunications devices (e.g. Smartphone and phone number), and financial institution a payment server. When a payee (merchant) and wish to do a financial transaction, the payee requests a TID from the server for that amount. The server sends a TID to the payee, which the payee then communicates to the payer. The payer in turn relays this TID to the server, which validates the transaction using the payer device. The server then releases funds to the payee. The server preserves records for auditing, but security is enhanced because the merchant never directly accesses the customer's financial account. Use of GPS coordinates and/or payer provided Group IDs may also be used to reduce the number of symbols used in the TID while continuing to ensure uniqueness.

### CROSS REFERENCE TO RELATED APPLICATIONS

This application is a continuation in part of U.S. patent application Ser. No. 13/325,291 “SYSTEM AND METHOD OF ELECTRONIC PAYMENT USING PAYEE PROVIDED TRANSACTION IDENTIFICATION CODES”, filed Dec. 14, 2011; application Ser. No. 13/325,291 in turn claimed the priority benefit of U.S. provisional patent application 61/559,118, “Per Transaction ID based Payment Method for On-line and in-store Purpose using Mobile Phone”, filed Nov. 13, 2011; this application also claims the priority of U.S. provisional patent application 61/834,582 “SYSTEM AND METHOD OF ELECTRONIC PAYMENT USING PAYEE PROVIDED VERY SHORT TRANSACTION IDENTIFICATION CODES”, filed Jun. 13, 2013; this application also claims the priority benefit of U.S. provisional patent application 61/836,152 “SYSTEM AND METHOD OF ELECTRONIC PAYMENT USING PAYEE PROVIDED VERY SHORT TRANSACTION IDENTIFICATION CODES”, filed Jun. 18, 2013; this application also claims the priority benefit of U.S. provisional application 61/836,232 “SYSTEM AND METHOD OF ELECTRONIC PAYMENT USING PAYEE PROVIDED VERY SHORT OR NULL TRANSACTION IDENTIFICATION CODES”, filed Jun. 18, 2013; all of these applications were invented by inventor Millind Mittal; the complete contents of all of these applications are incorporated herein by reference.

### BACKGROUND OF THE INVENTION

1. Field of the Invention

This invention is in the field of computerized payment methods for commerce and ecommerce.

2. Description of the Related Art

As electronic financial transactions have expanded, exemplified by the widespread use of credit cards for nearly all types of both direct and electronic commerce, so too has the risk of fraudulent financial transactions also expanded. Although much prior effort in security has been devoted to foiling sophisticated “man in the middle” attacks through the use of secure and encrypted communications channels, the simple fact remains that there is almost no defense against low- technology fraud. It is simply all too easy, for example, for an unscrupulous store clerk to write down a customer's credit card number, and then quickly ring up hundreds or even thousands of dollars in unauthorized charges on this card later.

The problem is bad enough when a customer is engaging in face to face transactions at a store counter, but at least there the customer can watch the clerk, and potentially identify the clerk later if necessary. By contrast, when the transaction takes place at a distance, such as by phone or by internet, the customer can't watch the clerk, and has no way at all to identify the clerk.

As a result, many individuals are leery of engaging in long distance electronic financial transactions. Although many financial agencies, such as credit card companies, do have a process for tracking down fraud and reimbursing the customer for fraudulent transactions, the process is slow and painful, as well as adding to the overall financial costs (i.e. overall credit card fees, and the like) to the system.

In an effort to resolve this type of problem, there have been a number of efforts to devise various types of electronic payment systems, exemplified by Paypal and Ericsson IPX mobile payments.

In one such scheme, exemplified by PayPal, the payer (i.e. customer) creates an account with a PayPal network payment server that is generally accessed through the network payment server's client interface (e.g. the PayPal payment server's web browser, or a PayPal linked auction website such as eBay, and the like). The PayPal network payment server then links the payer's account to the payer's credit card, bank account, or other existing source of funds, and also generates a PayPal payee ID (PayPal ID, often based on the payee's email). The payer then pays the payee using his PayPal ID for payment.

The PayPal system is useful for online purchases, but since the PayPal account information (e.g. the user's email, the user's PayPal account ID) continues to be both persistent and sensitive, there are still security concerns. For example, malicious websites which may present a dummy “Paypal look-alike” site for accepting payments. Separately, this system requires entering account information and hence is not as convenient for the user. Furthermore, this system is not suitable for making payments for in-store purchases.

In an alternative approach that is used by some mobile payment services providers, for example Ericsson IPX, to purchase online goods, the payer (i.e. customer) provides a mobile phone number to payee, which then presents the phone number to the Ericcson payment system. The payment system in-turn provides the payer with a passcode number (PIN). The payer gives this PIN to the merchant (payee). Upon receiving this PIN, the payee (merchant) then releases the on-line goods. The payment funds ultimately come from the payer's mobile phone bill.

The drawback of this approach is payer needs to share his personal information, for example phone number with the payee (merchant) site. Separately this process is bit inconvenient for the payer since he has to first enter information on the payee site and then read PIN from his cell phone, and then enter PIN into payee's online site.

### BRIEF SUMMARY OF THE INVENTION

The invention is based, in part, on the idea that what is needed to facilitate commerce is an alternate method of payment that utilizes a temporary and usually a one-time use transaction “identifier” or code (transaction ID). This transaction ID does allow a payment to be tied to a customer's (payer's) financial information, but does not require that the payer's sensitive financial information be transmitted to a potentially insecure merchant (payee) or other provider of goods and services.

The invention is further based, in part, on the idea that this transaction ID should preferably be short enough to be easily communicated by humans (e.g. a 10 character (symbol) or less code, rather than a large 30+ character (symbol) code). As previously discussed this transaction ID should often be good for only a single transaction, and/or be valid for only a relatively limited or bounded period of time, such as a week, day, hour, or even minute. Here the shorter the period of time in which the transaction ID is valid, the fewer the number of unique transactions that be supported by this particular transaction ID. This can result in improved convenience for the payer, but of course overly short time periods can also result in inconvenience and an occasional need to repeat valid transactions. This period can be adjusted to achieve a good tradeoff between security and convenience.

In some cases, the limited time period is a bounded time period with a start time, and end time, and therefore also a time length in which the transaction ID is valid (has not expired yet). In such situations, a payee could determine a future start time and end time of a particular bounded time period (thereby also determining a length of time) and may have control over this future start time and stop times. In other cases, this can be automatically established by system default values. For example, an automated payment system may operate with the default assumption that the start time is always automatically defined to be the time that the transaction ID is first established. The stop time (and thus also the length of time that the transaction ID is valid) can either also be automatically established as a default value (e.g. default value is one week), or either alternatively provided by a payee.

In one embodiment, the invention may be a computerized method of payment based on short, temporary, transaction ID numbers or codes which protect the security of the payer's (customer's) financial accounts. The payer will often initially register a source of funds and a payer device with a unique identification (ID) (such as a mobile phone and phone number) with the invention's payment server. Then once a payee (merchant) and the payer have agreed on a financial transaction amount, the payee can request a transaction ID from the payment server for that amount. The invention's payment server can generate and then transmit (e.g. send by direct electronic transmission, or through one or more intermediate servers) a transaction ID to the payee.

In this specification, assume that unless specified otherwise, all transaction ID are temporary transaction ID that expire at some point.

The payee can then provide (communicate) this transaction ID to the payer by a variety of methods (e.g. visual display from a payee device, electronic communication to a payer device, verbal communication between the payee and payer, audio communication from the payee device and so on).

The payer in turn relays (transmits) this transaction ID to the payment server, which then goes through the authorization of the transaction using the payer device. The payment server then releases funds to the payee. The server can also preserve all of these financial transaction details in persistent records for auditing purposes, but nonetheless security is significantly enhanced because the merchant and our hypothetical unscrupulous clerk can never get direct access to the customer's financial account information.

In some embodiments, the payee may be willing to accept a variety of different (multiple) payment services that could be utilized for payments, including transaction ID payments from multiple (different) transaction ID payment servers, possibly run by different organizations. In this case, when the payer is ready to indicate to the payee that it is ready to pay, the payer can also communicate the payer's payment server identifier to the payee. This payment server identifier may, for example, be the name of the payment service associated with the payment server, the network address of the payment server, or other form of identification method suitable for establishing communication between the payee and the payment server. The payee can then use the identified payment server for the transaction.

In some embodiments, the payee request for a transaction ID may be made via an intermediate server. The intermediate server will generally comprise at least one processor, memory, and intermediate server software. In this case, along with the amount to be charged, the payee will often also provide the intermediate server with a payment server identifier.

The payee will typically have a communications device comprising at least one processor, memory, and payee software; and often a display (e.g. bitmapped liquid crystal display or other type of computer controlled display) as well. In some embodiments, instead of being connected to the transaction ID payment server through a telecommunications network, the payee's communications device may instead be connected, through the telecommunications network, to an intermediate server that runs a separate payment collection service, running on an intermediate server that is a payment collection server. This payment collection server acts as payee's agent, and it can be separate from the transaction ID payment server. This payment collection server will also generally comprise at least one processor, memory, and payment collection software.

In some embodiments, instead of the payee requesting the transaction ID, the payment collection service itself requests the transaction ID from the payment server. Here the payment collection service essentially acts, on behalf of the payee, as payee's agent to receive the transaction ID. In this case, with respect to the payment server, the payee's agent itself can be viewed as a payee. In this situation, the principal payee for which the agent payee is performing the transaction ID process for may be referred to as the “primary payee”.

Various types of payee agent payment collection services are known in the art. One example of the use of such an intermediate server based, payee agent payment collection service, is when a payee (merchant) offers an option of accepting payment using Paypal as the payment collection service. In this case, Paypal can present the payer with multiple payment options (e.g. use various different credit cards, use Paypal account), and the payer can select one of them for making the payment. Irrespective of which payment method and service the payer selects, Paypal acts as an intermediate (agent) payment collection service on behalf of payee.

According to the invention, the transaction ID method can also be presented by an agent or intermediate payment collection service, such as Paypal, as yet another payment option. When this is done, the request for the transaction ID may be initiated by the payment collection service, and the transaction ID payment server will instead release the payments to the payment collection service. The payment collection service in turn can store the payment on behalf of the payee, or release the payment to the payee.

Using the invention's payee provided transaction ID method and system, consumers can now feel free to order products and services either directly (i.e. face to face, such as in a coffee shop purchase of coffee), or by telecommunications (e.g. phone or internet sales) knowing that the transaction ID that is used for this particular financial transaction cannot be used against them for unauthorized purchases.

More specifically, the invention protects the customer's sensitive financial information because the transaction ID is not bound, linked, or otherwise associated with the payer's financial account until the payer enters the transaction ID (usually through a secure communication channel) to the payment server. An additional advantage of this approach is that the payer can further ensure that the payment amount that the payment server releases to the payee for that particular purchase is exactly the payment amount that the payer had previously agreed to pay. This is because the invention's payment server can subsequently obtain electronic authorization from the payer for that specific payment amount. The invention's payment server may also send additional confirmation messages, for example a confirmation email to the payer's email address, at the conclusion of the transaction as well.

One of the benefits of the invention is that, relative to prior art methods, the payer user experience is often simpler and more convenient. This is because, according to the invention, once the transaction ID is provided by the payee (merchant), the payer's (customer's) subsequent steps of submitting the transaction ID, as well as the payer's subsequent validation of the transaction, can be both done in sequence on the payer's device, without the need for the payer to have any intervening interaction with the payee.

Although the transaction ID thus protects the payer's identity and financial accounts to a much greater extent than prior art methods, the invention's payment server can nonetheless also comply with all relevant financial regulations regarding the traceability of financial transactions. This is because the payment server will still contain complete records of the payer's (customer's) identification, the payee (merchant's) identification, as well as the funding amounts, the time of the transaction, and the source of funds used.

Thus to summarize, the present invention provides the very high degree of payer security that results when a transaction can be completed without providing either access or knowledge of the highly sensitive and confidential payer information to the payee (merchant).

### BRIEF DESCRIPTION OF THE DRAWINGS

FIG. 1 shows an overview of the interactions between a payee (such as a merchant), a payer (such as the customer), the invention's transaction ID based payment server, and optional third party funding sources such as banks or credit cards.

FIG. 1A shows an alternate embodiment in which the purchase telecommunications device is different from the default telecommunications device, and/or in which manual payments are made.

FIG. 2 shows how a source of payer funds, such as a particular payer credit card, can be linked or associated with a device that the payer has, such as a mobile phone, which will typically be identified by a unique payer device ID such as the payer's mobile phone number.

FIG. 3 shows a payee (e.g. merchant), selling products or services such as a widget for $5.98. Once the payer (e.g. customer) indicates an interest in the widget and desire to pay by transaction ID, the payee contacts the invention's payment server, indicates the widget amount (e.g. $5.98), and requests a specific transaction ID for that amount. The payment server then generates this transaction ID and sends it to the payee.

FIG. 4 shows how the payer (e.g. customer) after receiving the transaction ID from the payee (e.g. a merchant) can then transmit the transaction ID to the invention's payment server, and then confirm the transaction using the payer's previously identified and validated device (e.g. mobile phone). At this point, the payment server will now have enough information to complete the transaction.

FIG. 5 shows how the payment server, optionally in conjunction with one or more third party funding sources such as banks or credit cards, can then authorize the transaction and begin the process of transferring payer (customer) funds to the payee (merchant).

FIG. 6 shows an embodiment that uses Global Positioning Satellite (GPS) or other location data to enable shorter length transaction ID codes.

FIG. 7 shows an embodiment of a Group ID (GID) enhanced scheme that operates with shorter length unique transaction ID codes.

### DETAILED DESCRIPTION OF THE INVENTION

As previously discussed, one embodiment, the invention may be a computerized method of payment based on short, temporary or transient, transaction ID numbers which protect the security of the payer's (customer's) financial accounts. The payee will first register a source of funds and a payer device with a unique ID (such as a mobile phone and phone number) with the invention's payment server. Then once a payee (merchant) and the payer have agreed on a financial transaction amount, the payee requests a transaction ID from the payment server for that amount. If this payee request for a transaction ID is made via an intermediate server, the payee, along with the amount to be charged, will usually also transmit the payment server identifier to the intermediate server. The payment server sends the payee a transaction ID, which the payee then provides (communicates) to the payer. The payer in turn relays this transaction ID to the payment server, which validates the transaction using the payer device. The payment server then releases funds to the payee. The payment server can preserve all records for auditing purposes, but security is enhanced because the merchant never gets direct access to the customer's financial account information.

If the request for a transaction ID is made by payment collection service linked to the payee device, then after the validation of the transaction using the payer device, the payment server can release the payment to payment collection service, which as previously discussed can either keep or store the payments on behalf of the payee, or in turn release the payment to the payee.

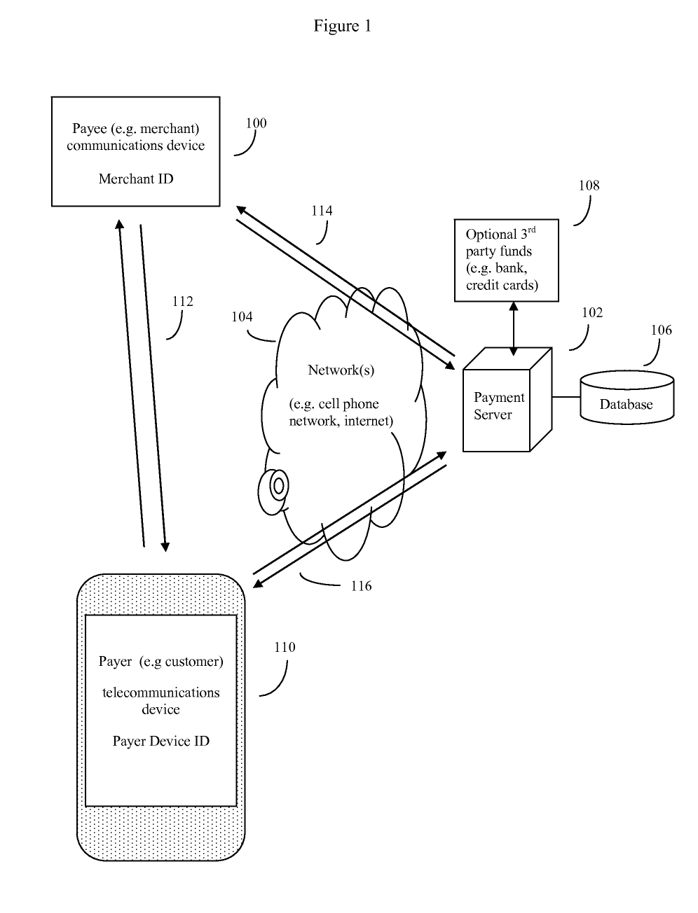

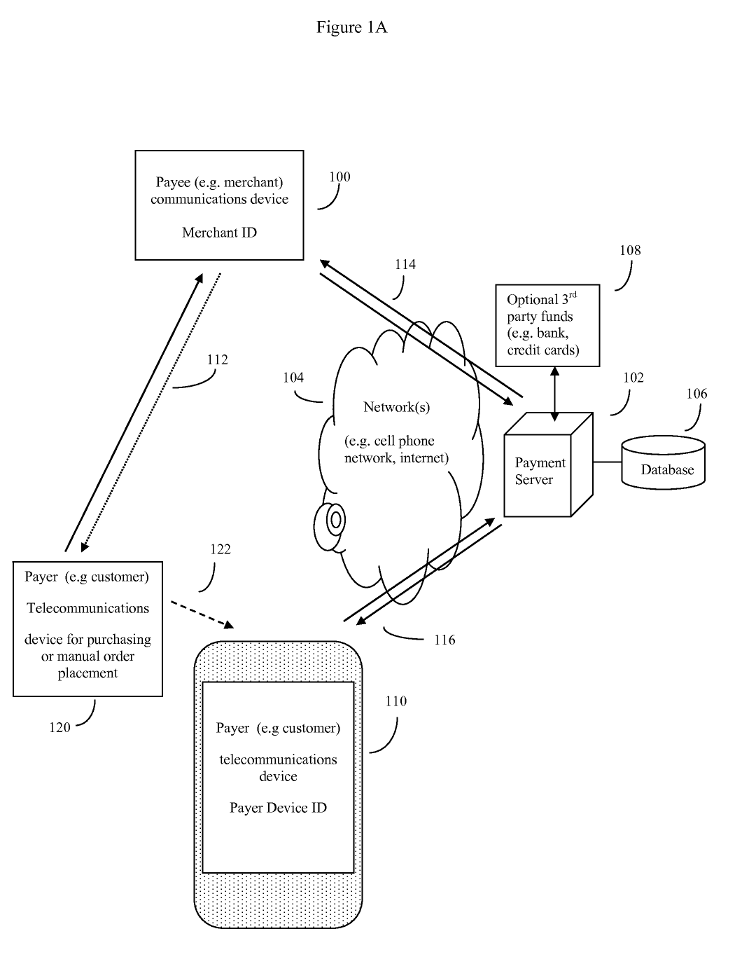

FIG. 1 shows an overview of the interactions between a payee (such as a merchant), a payer (e.g. customer), and the invention's payment server. The payee will have a payee communications device, such as a simple dumb phone, mobile phone (basic feature phone or a smartphone), tablet computer, desktop computer, laptop computer or other device (100). This payee communications device (100) is capable of establishing a connection to the invention's payment server (102) using one or more networks, using either standard phone lines, mobile phone connections, or the Internet as well as private networks and/or all combinations of such networks (104).

Thus in more detail, the payee communications device could be as simple as a “dumb” landline phone that connects to the invention's payment server (102) via a voice connection, or alternatively a more sophisticated communications device equipped with a processor (e.g. microprocessor), memory, and software, such as a mobile phone, smartphone, handheld computer, tablet computer, desktop computer, or laptop computer. The communications device may also have a web browser, and some or all of the transaction may take place by the web browser. The main criteria for communications device (100) is that it be capable of being linked to a unique merchant identification (ID) so that the invention's payment server can verify the identity of the payee who is using communications device (100).

The invention's payment server (102) will often comprise one or more processors (e.g. microprocessors), memory (e.g. RAM, Flash memory), software, network connection devices, and persistent memory storage such as disk drives or other persistent memory device used for database purposes (106). The payment server (102) may access this persistent memory storage (106) using standard database software (e.g. MySQL) or custom database software as desired.

Payment server (102) may also be a web server, in which case it will also run web server software such as Apache and the like, often assisted with various types of scripting software (e.g. Ruby, Perl and the like), and serve web pages suitable for payer and payee interaction.

Payment server (102) may also have other devices, such as speech recognition and speech synthesis devices, to facilitate audio communication when such audio communication is desired.

Payment server (102) will often be connected to optional third party sources of funding and/or credit verification (108). These third party sources can include various banks, credit card companies, and other traditional or non-traditional sources of funds that may potentially be used for the various financial transactions. If the organization that runs the payment server (102) is itself equipped with adequate financial resources, then the optional third party sources (108) need not be used, or alternatively may be replaced by credit rating agencies and the like.

The third leg of the system is the payer (e.g. the customer), who will generally interact with the system using a payer telecommunications device (110). This device (110) will often be a mobile phone, smartphone, tablet computer, laptop computer, desktop computer, or other computerized device capable of storing a unique identification token, and/or equipped with a payer biometric sensor (e.g. fingerprint sensor). In a preferred embodiment, this device (110) is a mobile phone or smart phone that will preferably be capable of sending and receiving Short Message Service (SMS) and/or text messages. The payer telecommunications device (110) will generally be capable of at least establishing a network connection with the invention's payment server (102), and often (but not necessarily always) with the payee communications device (100) also.

Note that it is contemplated that some or all of the invention's methods will be implemented in the form of computer software running on payment server (102), and the description in this specification may be viewed as being a functional description of the various actions and software implemented methods that the payment server will implement according to the invention. Thus in one embodiment, all of the custom functionality of the invention may be implemented on payment server (102). In this case, payee computerized device (100) and payer telecommunications device (110) may simply interact with the invention's software running on payment server (102).

In other embodiments, the invention's methods may also be implemented in part through the use of custom applications software (e.g. apps) running on devices such as payer telecommunications device (110) or even payee communications device (100). Additionally, when payee communication device (100) is a web server, it may serve web pages intended to run under the control of processor(s) in devices (110) and/or (100), which may perform various functions such as display of transaction ID's, data input, control of biometric sensors, and the like.

Note that communications between the payee (100) and the payer (110) need not be either machine based or pass over a communications network, although they may be. Here any method of communicating information (112), ranging from wireless, infrared, electronic, optical and audio methods up to and including talking, writing, pointing, sign language, or even carrier pigeon, drum beats, or smoke signals can be used. In some embodiments, such as when a customer is talking to a clerk at a check-out counter, the communications (e.g. the exchange of transaction ID) between the customer using device (110) and the merchant (using device 100) can be verbal or written. Thus a simple verbal statement: “The transaction ID is 352431 for your purchase” can be sufficient for communications link (112), and link (112) need not be over a network (104), although it may be. Alternatively the merchant payee (100) may use a customized device, such as a modified terminal or cash register, that displays the transaction ID directly, which the customer can then observe and enter in to his own device (110). By contrast, communications to and from the payment server (102) will generally proceed by a network such as (104) for both communications device (100) (e.g. 114) and communications device (110) (e.g. 116).

Thus, more specifically, in one embodiment, the invention may be a transaction ID method of payment, comprising a payment server (102) connected to a telecommunications network (104). This payment server will generally comprise at least one processor, memory, and payment software. As previously discussed, this payment server will generally be linked to at least one payment source such as 3^{rd} party source (108), or alternative source of funds.

The invention will also generally require that there be at least one payer telecommunications device (110) connected to the telecommunications network (104).

Usually, before a transaction of interest commences, some preliminary steps will be performed. One step is the step of using the payer's telecommunications device (110) to communicate with the payment server (102) and inform the server that a payer source of funds (e.g. a payer credit card number, bank account, or the like) should be linked to the device ID of the payer's telecommunication's device (110).

FIG. 1A shows an alternate embodiment in which the purchase telecommunications device (120) may be different from the default telecommunications device (110), and/or in which electronic payments are made. Here for example, the payer may be communicating with the merchant over a land line telephone or using a web browser on an alternate device (120), receiving the transaction ID from the payee (112) using that alternate device (120), and then providing (communicating) the transaction ID to payer, which the payer then relays (122) to the payer's telecommunication's device (110).

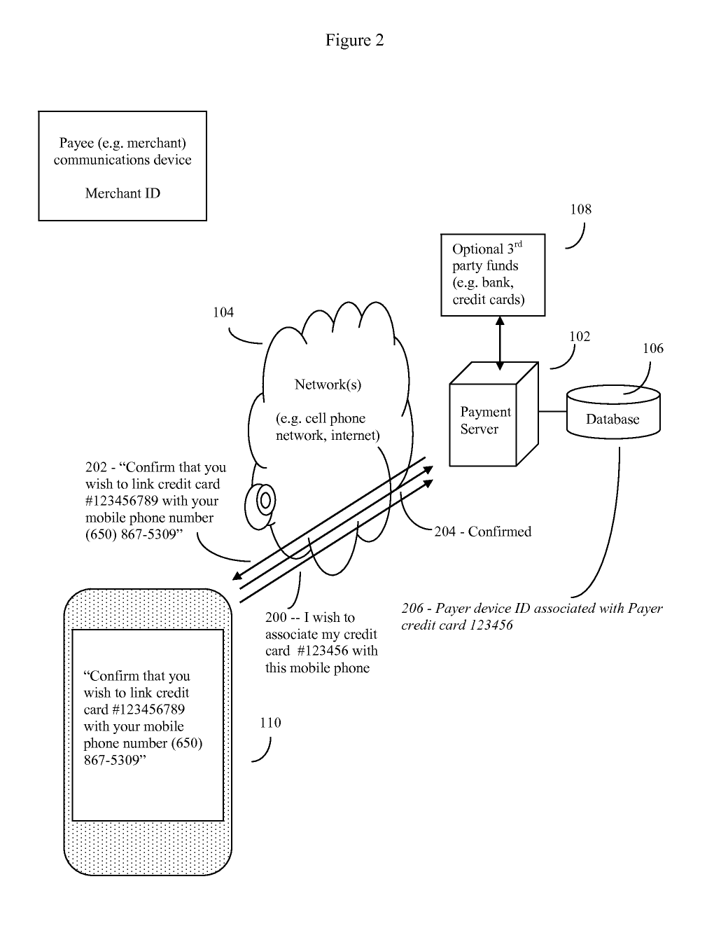

FIG. 2 shows how a source of payer funds, such as a particular payer credit card, can be linked or associated with the payer's telecommunications device (110). When device (110) is a mobile phone, it may conveniently be identified by a unique payer device ID such as the payer's mobile phone number. As previously discussed, alternative payer ID's such as the payer biometric signatures (e.g. fingerprints) can also be used, and here for simplicity such alternative schemes will also be designated as a payer device ID. The larger idea is simply to link a payer financial account with something that the payer has, be it device or be it a payer biometric signature or other payer object.

To do this linkage, the payer can use device (110) to contact the invention's payment server (102), and communicate both the payer's device ID and the payer's financial account number (e.g. credit card number) to the payment server (102), which will in turn store this information in its database (106). Thus for example, in the case where the payer is using a mobile telephone or smartphone, the payer can use either an application running on the smartphone, SMS messaging, text messaging, or even voice messaging (using caller ID) to transmit, for example, “I wish to associate my credit card # 123456 with this mobile phone” (200). The payment server in turn indicate that it has received this request (202) “Confirm that you wish to link credit card #123456789 with your mobile phone number (650) 867-5309”, optionally check to ensure that funds are actually available with 3^{rd} parties (108), and often upon receiving a final confirmation from the user (204) then store this association between the payer's telecommunication device and the payer's funding account in database (106) as (206).

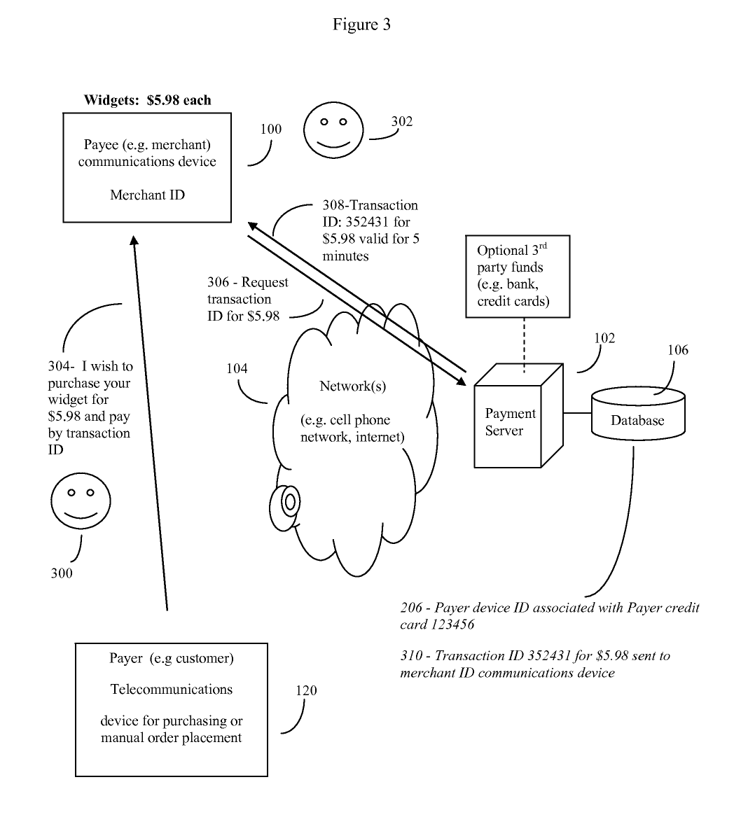

Additionally (not shown) prior to initiating the transition ID based financial transaction, the (e.g. FIG. 3 payer (300) and the payee (302)) will presumably have conducted preliminary negotiations regarding the item or service to be purchased, and the price of the item or service. These preliminary negotiations need not be done using any sort of device at all (although devices (100), (110), (120) may be used). Thus for example, payer (300) could simply speak directly to a merchant/payee (302) at a counter, and accept the merchant's bid for the $5.98 widget by direct verbal offer such as (304), “I wish to purchase your widget for $5.98 and pay by transaction ID”. Alternatively the payer can accept the offer by other means, such as by clicking on an item on a merchant website.

For example, assume that a payee (e.g. a merchant) (100) is selling a “widget” for $5.98. (Here the term widget can mean either goods or services).

This is shown in FIG. 3. Once the payer (e.g. customer) indicates an interest in the widget and desire to pay by transaction ID, the payee (100) contacts the invention's payment server (102), indicates the widget amount (e.g. $5.98), by a voice or machine message such as (306), “Request transaction ID for $5.98”. The payment server (102) will generate a transaction ID for this, such as (308) “Transaction ID: 352431 for $5.98 valid for 5 minutes” and transmit this back to the payee device (100). The payment server (102) will also save a record of the transaction ID number, the payment amount, and the merchant ID in its database (106) as (310).

As previously discussed, this transaction ID is preferably a transient (i.e. one time use, limited time use, or both) transaction ID that may in a preferred embodiment be relatively short (e.g. 10 alphanumeric characters in length or shorter) and intended for convenient manual or spoken data entry by unskilled users. Generally the transaction ID will be intended for one-time use only within the time window in which the transaction ID is valid. The length of this time window may be determined as desired by the system operators, with a time duration in which the transaction ID is valid on the order of weeks, days, hours, or even minutes (e.g. 1 minute, 5 minutes, 1 hour, 1 day, 1 week and so on). In a preferred embodiment, this transient transaction ID may be generated in a manner (e.g. randomly selected) that does not provide any hints to the actual payee financial account (e.g. credit cards) number. Indeed note that in many embodiments, the transaction ID will be generated by payment server (102) before the payment server even knows who the payer is.

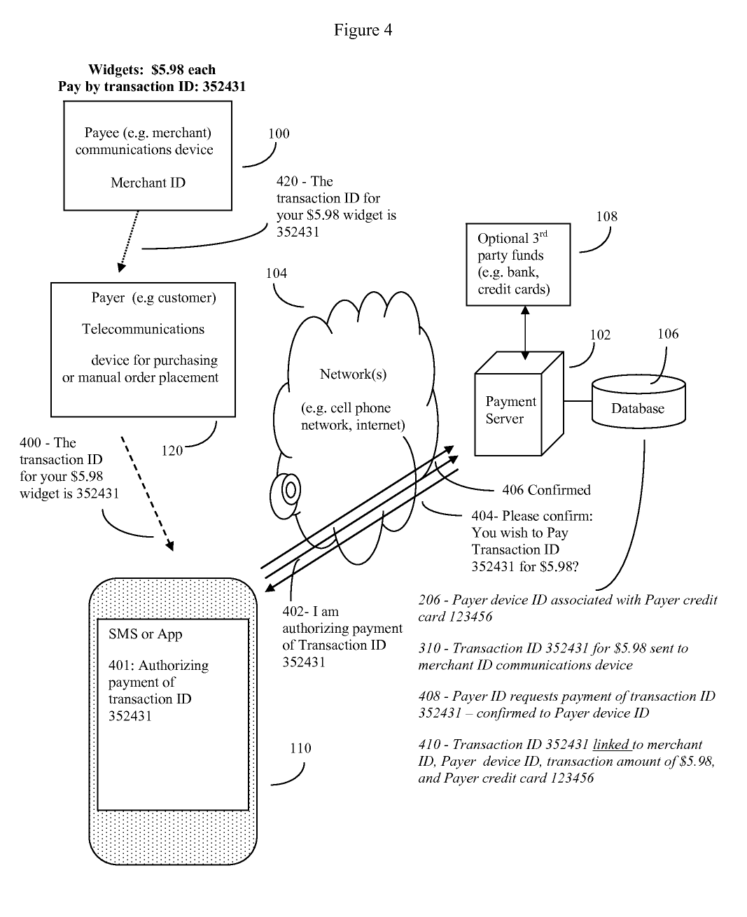

FIG. 4 shows how the payer (e.g. customer) (110) after receiving the transaction ID from the merchant (100) (by any communications means, for example by reading the displayed transaction ID on a communication application portal running on payee device (100), by direct contact, or other method) (e.g. (400)/(420), or via (120), (420), to (400) can then transmit the transaction ID (402) to the invention's payment server (102), often via the payer's telecommunications device (110), (401)). Once the payment server (102) requests confirmation (404), the payer can then confirm (406) the transaction using the payer's previously identified and validated telecommunications device (e.g. mobile phone) (110). At this point, the payment server (102) will now have enough information (408), (410) in its database (106) to complete the transaction.

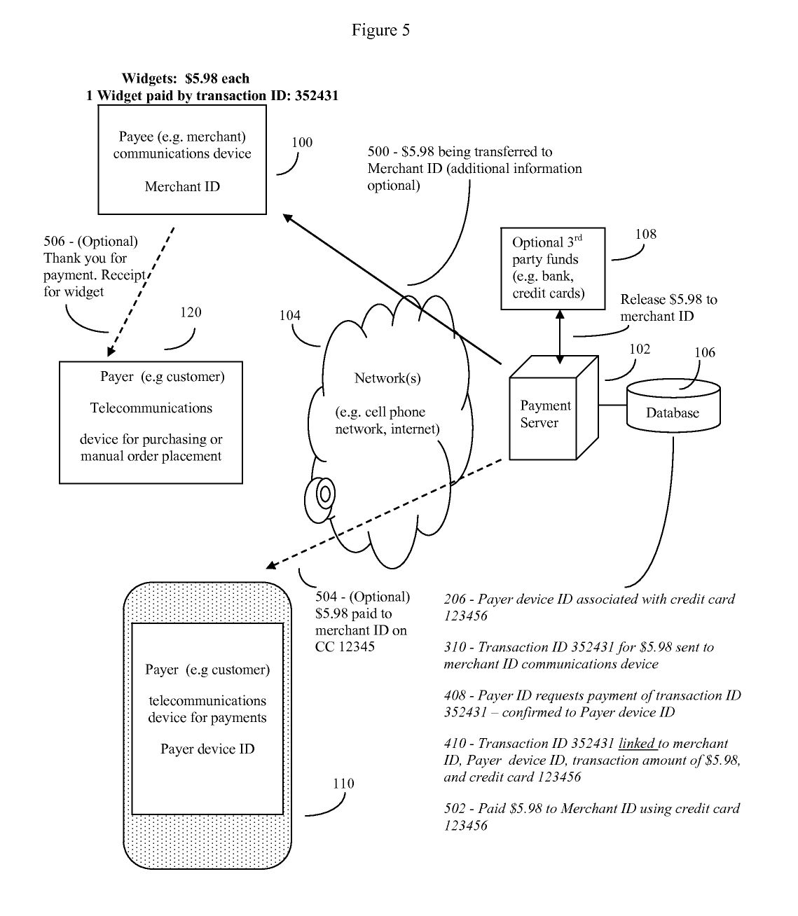

FIG. 5 shows how the payment server (102), optionally in conjunction with one or more third party funding sources such as banks or credit cards (108), can then authorize the transaction and begin the process of transferring (500) payer (customer) funds (110/300) to the payee (merchant) (100/302). The payment server can then record this payment in its database (106), (502), and also generate and send optional confirmation messages (504). The payee (100/302) in turn can also optionally send additional confirmation messages (506) to the payer (110/300) as well, either directly to telecommunications device (110), or alternatively to other devices (120).

Again the payment source for the transferred funds may be a 3^{rd} party payment source (106) or the organization running the payment server (102) may elect to provide the funds directly without use of a third party.

Once either the transaction has completed, and/or the allocated time period (e.g. 1 minute, 1 hour, 1 day, 1 week, 1 month) for the transaction ID to be valid has expired, the transaction ID used for this transaction will become invalid and will no longer be honored by the payment server (102). Thus the payer has the assurance that additional unauthorized transactions will not be occurring, and additionally has completely hidden his or her normal financial account information from the payee (merchant), thus additionally reducing the chances of fraud.

As previously discussed, the payment server (102) will then persistently store this transaction information in its database (106) in order to comply with various financial regulations and statutes. This persistently stored information will generally consist of at least the identification information pertaining to said payee, identification information pertaining to said payer, time of transaction, said payment amount, and said transient transaction ID. This allows the complete financial transaction to be later retrieved and audited by authorized individuals and agencies as needed.

In other embodiments, GPS data may be used to provide even shorter or smaller transaction identification data (ID), thus improving user convenience still further.

In these embodiments, the length of the transient transaction ID alphanumeric text or number may be made still smaller by utilizing the payee and payer telecommunication devices' GPS (Global Positioning Satellite) location coordinates, other proximity determination method, or other location determination method. Here, the basic idea is that in situations where both the payee and payer are in relatively close geographic proximity or vicinity to each other, then a still smaller transient transaction ID is sufficient to allow the payment server to uniquely bind the payee, payer and a given transaction together. How close a “close proximity” must be can be determined by the system at hand, or by the payee, but as a default value will often be a value of not greater than a 300 feet distance between the two telecommunications devices. Other distances (e.g. within 10 feet, 3 feet, and so on may also be specified). At the same time, there is generally no requirement that the two telecommunications devices actually be brought into direct contact (e.g. generally no “bumping” step will usually be required), although lower distance limits may also be specified by the system or operator as desired.

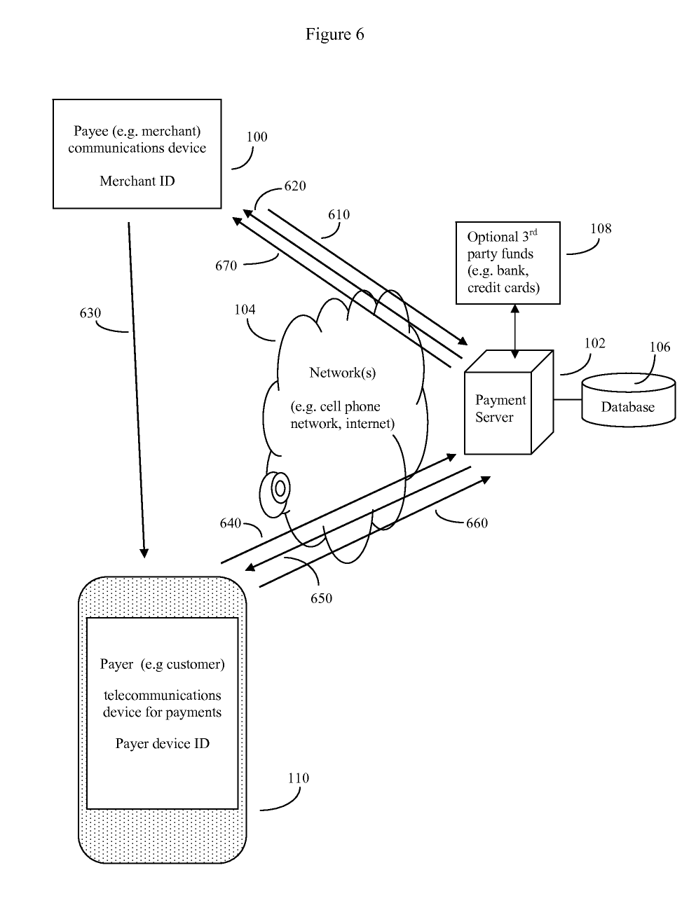

FIG. 6 shows this processing flow as steps 610 through 670. In (610), the payee initiates a request for a transient short unique Transaction ID, and the payee provides the payee's GPS coordinates. In (620), the payment server provides a transient short unique Transaction ID to the payee. In (630), the payee also provides a transient short unique Transaction ID to the payer. In (640), the Payer provides a transient short unique Transaction ID to the payment server along with the Payer's GPS coordinates. In (650), the payment server matches the GPS location of the payer with the GPS location of the payee, and assuming a match, also matches the transient short unique Transaction ID previously provided to the payee with the transient short unique Transaction ID that the payer gave to the payment server. If they match, then the payment server presents the invoice to the payer. In (660), if the payer wants to pay the invoice, then the payer approves the invoice, provides a payment method, and sends the approval (and payment method if needed) to the payment server. In (670), the payment server transmits a transaction success notice to the payee, and credits the invoice amount to the payee's financial institute.

Thus FIG. 6 (610) thru (670) shows an example of how payment systems based on payment system generated, and payee provided transient short transaction ID codes for carrying out the payer to payee payments for a given transaction can operate. In this system, the size of the transient transaction ID can be further reduced by limiting the region for which the generated transient transaction ID is valid to a small geographical area. For example, the generated transient transaction ID needs to be valid and unique only for those payer/payers whose telecommunication device, and hence the location of the payer/payers themselves, is/are within the limited region around the payee telecommunication device, and hence the location of the payee.

Here, the valid region around the payee telecommunication device can be limited by, for example, having the payment server require that the GPS coordinates be (co-related) (e.g. to be within a small maximum distance range of each other). Note that such payer-payee maximum distance range limitations may also be done through other electronic means. For example, the payment server may require that both telecommunications devices be connected to the same unique Wi-Fi device, both devices be within Bluetooth® range of each other, both devices be within the same triangulation range for cell phone towers, and the like.

Note that the processing flow shown in FIG. 6 is an example, and some incremental modifications to the processing flow can be made without violating the spirit of the processing flow.

In other embodiments, proximity establishment may be done through some other means other than the GPS coordinates. Alternatives may include access to same cellular phone towers, WiFi transceivers, and the like.

The system may be further extended to a multi-party payment system where the shorter temporally unique transaction ID may be used by multiple payers to pay a payee if all of the payers telecommunication devices, and hence payers, are in the same “geo-fence” area) (GPS coordinates are within the scope of proximity requirement imposed by the system.

In a multi-party payment system where there are multiple payers for one payee, payee may explicitly indicate to the payment server during initial transmittal of the transaction information to the payment server as to how many payers, say ten payers, will be sending the payment for a given payee before the transaction ID is closed out. In some embodiments, payee may also request for some explicit duration , say a few days, for which transaction ID should be kept valid by the payment server, so that all of the payers have had enough time to make the payment.

Alternatively, in another embodiment, either the payee or the system may specify that the transaction ID will be valid only so as long as the transaction ID is displayed (often continuously displayed) by the payee on the display of that payee's telecommunication device. Note that any and all of these various transaction ID time durations can be used, as desired, in essentially any and all embodiments of the invention described herein.

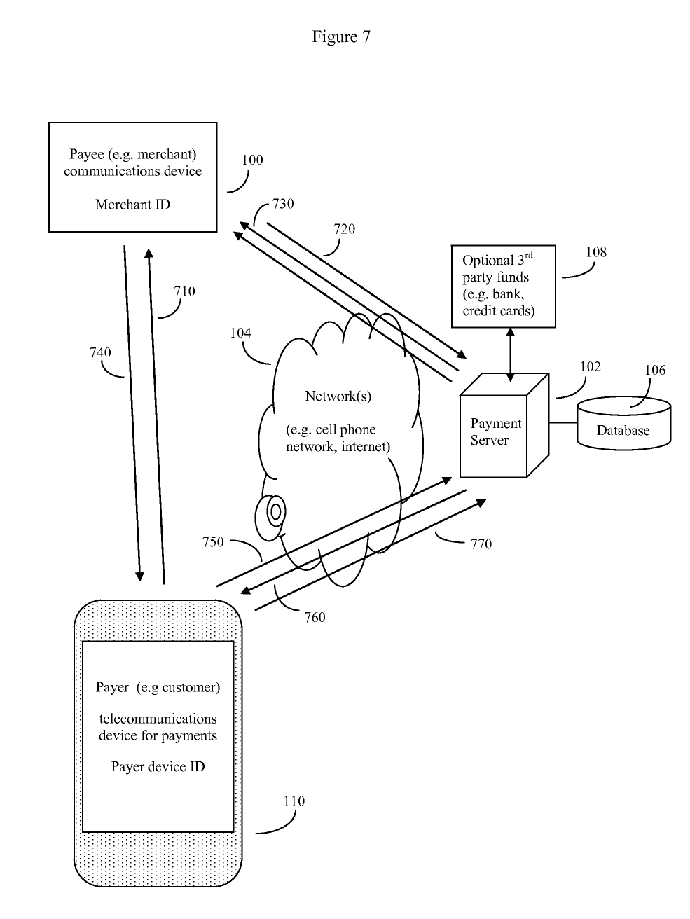

FIG. 7 shows an example of some other methods that may also be used to reduce the length of the transient Transaction ID. In other embodiments, the payment server may generate transient transaction IDs that are unique only amongst a group of payers. In this embodiment, for example, some or all of the potential pool of payers may be divided into different groups. Each group may be identified based on a Group Identification number or Group ID (GID). Here “Group ID” and “GID” will be used interchangeably.

In (710), the payer provides a GID to the payee. In (720), the payee in turn transmits this payer GID to the payment server, and also requests the payment server provide a transient unique short Transaction ID. In (730), the payment server transmits a transient short unique Transaction ID to the payee. In (740), the payee in turn provides this transient short unique Transaction ID to the payer. In (750), the payer in turn transmits this transient short unique Transaction ID to the payment server, and also transmits an indicator that the payer wants to use a short transient unique Transaction ID system that uses GID. In (760), the payment server matches the transient short unique Transaction ID originally provided by the server to the payee in step (730) with the transient short unique Transaction ID transmitted to the server by the payer in step (750). Assuming that the two transient short unique Transaction IDs match, then the payment server will then transmit the invoice to the payer. In (770), assuming that the payer agrees to pay the invoice, then the payer will transmit approval of the invoice and may also provide a payment method to the payment server as needed.

In the GID scheme, some information used for creation of the GID could be one or more of: 1) a part of the phone number used for the mobile payment solution; and/or 2) some of the characters from the user name (if any) used by the payer to bind its mobile payment client to the payment server. (If part of the phone number is used, note that the larger the part of the phone number used, the smaller the payment group size, so for example, if the full phone number of the payer is used as the GID, then the group size would degenerate to “1”. The case when there is only one candidate payer in the system and there is only one transaction that is active, payment server can effectively provide a very short or even a NULL transient transaction ID—Note that the NULL transient transaction ID still binds a specific transaction to a specific payee and payer)

In other embodiments, the payment server itself may provide a GID to the payer.

In these embodiments, the payment system payer can present their GID to the payee prior to payee's subsequent request to the payment server for a transient transaction ID. The payee then presents the payment system payer's GID to the payment server, along the request for the transient transaction ID. The payment server will then generate a unique transient transaction ID for a group of payers identified by this supplied GID.

Since the payment server now only needs to be able to pair up a candidate payer with a comparatively small group or pool of payers with the same GID, rather than with the entire universe of potential payers, then the length of the transient transaction ID can also be shorter than it would be otherwise. This shorter length unique transaction ID may then be passed to the payer by the payee. The payer can then present it to the payment server as before.

The system may operate either with or without the use of GID. Mode switching between GID using and GID non-using methods can be done by various ways. In some embodiments, the user or system may explicitly specify that GID methods are being used. Alternatively, use of GID may be set as the default option.

Other alternate schemes may also be used to reduce the length of the transient transaction ID. In principle, any additional type of payer to payee information may be used. This can include information such as the payer's favorite color, favorite food, type of figurine on the payee's counter, first few digits of the payee's address, and the like can also be used as supplemental information that can reduce the length of the transient transaction ID. In some implementations, number may correspond to last few digits of the number or any other information allowed for Payer to provide to payee to identify the Group ID.

Note that GPS coordinate and GID based methods themselves can be combined to create a degenerate case of single member in a group on a transient basis, i.e. until another member of the same GID enters the geo-space covering the payee and payer. In this case effectively need of entering a transient transaction ID by the payer may be removed so long as there is only one payer present with the same GID in the geo space covering the payer and the payee. In this case payment server essentially can indicate to the payee to provide payer NULL transient transaction ID, i.e. a simple indication that payment server has acknowledged that it has received the transaction information and now payer can start the payment process, i.e. request the payment server to present the transaction information, without having to make any explicit transient transaction ID entry.

As an example the last 4 digits of the payer's mobile device number may be used as a GID. Then in this case payer can present GID along with GPS to payment server. Payment server can present back a very short transient transaction ID along with an indication whether use of this transient transaction ID is optional in case there is only one payer present with the given GID in the geo-space around the payee. If the payment server presents with the indication to the payee that intended payer with GID is the only payer present in the geo-space around the payee, then payee can indicate to the payer to initiate payment steps on its mobile payment device without entering any explicit transient transaction ID. In this degenerate case payee provides an indication to initiate transaction with effectively “Null” transient transaction ID.

Note that in one implementation Payer may ensure that GID provided by it globally unique for the duration of the transaction. In this case, once the payer generates the GID, it first sends GID to the payment server to validate that the submitted GID is globally unique at the instance of the query. This is essentially adding a step before the step 1 of FIG. 7. Other steps stay the same. In this case by design the transaction ID is effectively guaranteed to be “NULL” as long as payee provides it to the payment server prior to payment server retires this GID from the valid poll of GIDs. If by the time payee provides the GID to the payment server, GID is not valid anymore, payment server indicate to the payee that the GID is expired or is not valid. Payee then instead of providing “NULL” code (which is simply marking/indicating or communicating to payer that it is now ok to make the payment, communicates to the payer that the GID provided is no longer valid and payer needs to regenerate the GID again.

In an alternate embodiment, Payer, instead of creating a GID, will simply do a query to payment server to provide a globally unique GID and then provide it to Payee. Rest of the flow will be similar to the case of payer generated GID.

In all of the cases payee to payer communication, besides being verbal or visual, may be over any electronic communication medium. Some of the low range, fast connection set-up electronic means, for example Bluetooth Low Energy (BLE) or even NFC technologies are particularly well suited. In such a system, BLE or NFC is integrated with payee telecommunication device, which in this case would be Point of sale terminal (PoS) or payment terminal. Other wireless electronic communication channels include Bluetooth(r), WiFi, and RFID devices. Indeed any short range (generally less than 300 foot range) wireless transmission method may be used in this regard. Note that these are just some examples and others are implied here as well. In case of BLE based systems, payee telecommunication device (PoS or payment terminal) may optionally communicate payee telecommunication device ID along with the transient transaction ID. In this case transient transaction ID can be made further smaller- it only needs to be unique with respect to transaction IDs for other payee telecommunication devices in the vicinity of the payee telecommunication device of interest. If payee telecommunication device can uniquely determine that there are no other BLE enabled payee telecommunication devices that can interfere with it, the transaction ID transmitted by the payee telecommunication device may be reduced to even a “NULL” transient transaction code.

Additionally communication channel may be based on use of camera. Payer telecommunication device may have a camera that captures the payee provided transaction ID and the application running on the payer telecommunication device then performs image Optical recognition techniques to determine the transaction ID being provided by the Payee.

Yet, another communication medium may be audio based. Payee telecommunication device may provide the transaction ID as audio waveform that is recognized by the payer telecommunication device to derive the transaction ID.

Thus to summarize, there can be various embodiments of the invention, including limited time (time bounded) embodiments, time and geographically bounded embodiments, and Group ID embodiments.

### Limited Time (Time Bounded) Embodiments

In some embodiments, the invention may be a transient transaction ID method of payment. This method may, for example, comprise at least one payment server connected to a telecommunications network (such as the Internet), and linked (usually electronically) to at least one payment source (e.g. a financial institution). As before, the payment server(s) will typically comprise at least one processor, memory, and payment software, and in some embodiments may be web servers. The method also generally comprises at least one payer telecommunications device that is also connected to this telecommunications network. This telecommunications device can be a variety of different telecommunications devices, and for example can be a mobile phone, smartphone, tablet device, or other computerized device capable of sending and receiving SMS and/or text messages. In some embodiments, the telecommunications device used by either the payer, payee, or both can be a web browser equipped computerized device (e.g. a mobile phone, handheld computer, tablet computer, desktop computer, or laptop computer) and at least some of the various transaction steps can be conducted using this web browser(s). Often the telecommunications device(s) used by one or both of the payee and payer will be computerized devices comprising at least one processor, memory, and telecommunications device software.

According to the method, at least one payee who wants to be paid (e.g. desires a payment amount from a payer) for a transaction will also typically be connected to this payment server through a payee communications device and the telecommunications network.

In this version, the payee will typically use his or her payee communications device to transmit the requested payment amount to the payment server, along with a request that the payment server generate a transient transaction ID for this particular transaction. (Note that if multiple payers are expected to pay for a transaction (e.g. a party of multiple people splitting a check at a restaurant), the payee may optionally also communicate how many payers will be paying for the transaction to the payment server as well.)

This transient transaction ID will typically be a short code that is valid for a limited (bounded) time period. For example, the transaction ID may be a 10 character or less numeric or alphanumeric sequence. The time length that the transaction is valid may be either set by the payment server, or alternatively in some embodiments, the payee can also determine how long the transaction ID should be valid, and transmit this desired validity time to the payment server as well. In some embodiments, the desired validity, or at least the default validity time, may be on the order of one week or less but of course this may be modified by users and/or system operators as desired.

Again, as previously discussed, in some alternative embodiments, the time that the transaction ID is valid may be set to be the duration for which that particular transaction ID is displayed on the display of the payee's telecommunications device.

For example, a payee may request a transaction ID from the payment server, and display this transaction ID on his or her payee telecommunications device. As long as this transaction ID is being displayed, then multiple payers use the same transaction ID to make the payment(s) to the payee. However in this embodiment, as soon as the transaction ID is removed from the display, then this transaction ID will no longer be valid for that transaction.

The payment server will then generate this transient transaction ID and transmit it to the payee. The payee in turn can transmit or otherwise provide this transient transaction ID to the payer.

The payee can use various methods to transmit the transaction ID to the payer. In addition to simple methods, such as looking at the transaction ID and just telling the payer what the transaction ID is, or showing the transaction ID directly to the payer, other methods can be used as well. For example the payee's telecommunication device can transmit the transaction ID to the payer's telecommunication device over various types of electronic communication channels. Here short distance wireless methods such as Bluetooth Low Energy (BLE) or Near Field Communication (NFC) may be used. Alternatively a camera on the payer's telecommunication's device (e.g. cell phone, smart phone) can capture an image of the transaction ID from the payee's telecommunication's device, and so on. Alternatively the payee can provide the transaction ID to the payer by speaking the transaction ID, or using some other audio channel (e.g. telephone, smartphone, etc.) to communicate to the payer.

The payer in turn (using the payer telecommunications device) can transmit the same transient transaction ID to the payment server. When the payment server receives this transient transaction ID from the payer, the server can then in turn transmits an authorization request to the payer telecommunications device. This authorization request will generally comprise at least the payment amount required for that transaction, as well as and a request for payer authorization. When the payer receives this authorization request (and assuming that the payer in fact does wish to authorize), then the payer can then in turn transmit the required authorization back to the payment server. Assuming that the payment server receives this authorization prior to the end of said limited (or bounded) time period, then payment server will use the payment source(s) (often a financial institution) to send the payment amount to the payee.

Note further that in some embodiments, the payee may be an intermediate server or payment collection server acting as the agent for a primary payee.

In some embodiments, when there is a plurality of payment servers, each server may be configured with its own server identifier. In these embodiments, the payer can also transmit this server identifier to the payee as well, and the payee can then use this server identifier to then carry on the above discussed transactions with the payment server corresponding to the server identifier.

Additionally, in some embodiments (often preferred embodiments), for auditing purposes as well as to comply with various regulatory requirements, the payment server can be configured to persistently store (usually in a database) identification information pertaining to the payee and payer, as well as other information such as the time of transaction, payment amount, transient transaction ID in a database.

Limited time (time bounded) and geographic (geographically bounded) embodiments:

In an alternative embodiment, the invention may use both time and geographic bounds. In these embodiments, as before, the invention is again a transient transaction ID method of payment, comprising at least one payment server connected to a telecommunications network, and again the method uses at least one payer telecommunications device connected to the telecommunications network as well. As before, least one payee desiring a transaction payment amount from one or more payers will use the method, and as before, the payee(s) will again be payee being connected to the payment server(s) by the same type of payee communications devices connected to the telecommunications network.

However in this embodiment, the payee transmits both the payment amount and the payee telecommunications device's current location coordinates (here the previously discussed GPS methods or other location determination methods may be used) to the payment server, generally when the payee is requesting that the payment server(s) generate a transient transaction ID for the desired transaction. As before, this transient transaction ID is will generally be valid for a limited (bounded) time period, and as before, the payment server will generate a transient transaction ID and transmit this to the payee. The payee can again provide this transient transaction ID to said payer. However this time, the payer will use his or her payer telecommunications device to transmit the transient transaction ID to the payment server along with the payer telecommunication device's current location coordinates (again GPS or other location determination methods may be used).

Thus the payment server receives both the transient transaction ID and also the current location coordinates of the payer's telecommunications device, and can verify that both the transient transaction ID match and that the coordinates of the payer and payee match as well. This verifies that the payee is in close geographic proximity to the payer. Assuming that both the transient transaction ID and the geographic coordinates match, then the payment server transmits an authorization request to said payer telecommunications device. As before, this authorization request will usually comprise both authorization request itself as well as the payment amount that is being authorized. As before, when the payer receives this authorization request, then assuming that authorization is desired, he or she can transmit the authorization to the payment server. Assuming that the payment server then receives this authorization before the limited period expires, then the payment server can then use one or more payment sources to send the appropriate payment amount to the payee.

### Limited Group ID (GID) Embodiments

In this embodiment, the invention may still be time bounded, but will also make use of the previously described Group ID methods as well. Here, as before, the invention is a transient transaction ID method of payment, again comprising at least one payment server connected to a telecommunications network, at least one payer telecommunications device connected to the telecommunications network, and at least one payee (with his or her own communications device connected to the telecommunications network) that desires a payment amount from the payer for a transaction. However in this embodiment, the payer will provide a Group ID to the payee, and the payee in turn will transmit both the payment amount and the Group ID to the payment server when requesting that the payment server generate a transient transaction ID for the transaction.

Note that in some embodiments, the payer may first check with the payment server and validate that a payer's proposed Group ID is globally unique (and therefore can in fact be validly used as a Group ID) before providing the Group ID to the payee. If the server finds that the proposed Group ID is unsuitable—not unique, then a different Group ID can be proposed and verified until finally a suitable unique Group ID is found.

In some embodiments, for better security and tracking purposes, the payee can also provide the payee's location (e.g. GPS coordinates) the payment server along with the Group ID.)

As before, this transient transaction ID is valid for a limited (bounded) time period. Upon receiving the above request, the payment server generates the transient transaction ID and transmits the transient transaction ID to the payee, and the payee in turn will payee provide this transient transaction ID to the payer. However in this embodiment, the payer will in turn use his or her payer telecommunications device to transmit both the transient transaction ID and the Group ID to the payment server.

Then when the payment server receives both the payer's transient transaction ID and the payer's Group ID, the payment server will check for a match between the transient transaction ID and said Group ID provided by the payer, as well as the transient transaction ID and Group ID that the payment server had earlier provided to the payee. Assuming that such matches are found, then the payment server will transmits authorization request (comprising at least the payment amount and a request for authorization) to the payer's telecommunications device. Once the payer receives this authorization request (and assuming that the payer wants to authorize), then the payer will use his or her telecommunication's device to transmits the authorization back to the payment server. Then assuming that the payment server receives this authorization before the limited time period expires, then the payment server will in turn direct the payment source(s) to send the payment amount to the payee.

Bluetooth® is a trademark of the Bluetooth SIG, Inc.

1. A transient transaction ID method of payment, comprising:
a payment server connected to a telecommunications network, said payment server comprising at least one processor, memory, and payment software, said payment server being linked to at least one payment source;
at least one payer telecommunications device connected to said telecommunications network;
and at least one payee desiring a payment amount from said payer for a transaction, said payee being connected to said payment server by a payee communications device connected to said telecommunications network;
wherein said payee transmits said payment amount to said payment server and requests said payment server generate a transient transaction ID for said transaction;
said transient transaction ID being a short code that is valid for a limited time period;
said payment server generates said transient transaction ID and transmits said transient transaction ID to said payee;
said payee provides said transient transaction ID to said payer;
said payer uses said payer telecommunications device to transmit said transient transaction ID to said payment server;
said payment server receives said transient transaction ID from said payer, and transmits an authorization request to said payer telecommunications device, said authorization request comprising at least said payment amount, and a request for authorization;
said payer receives said authorization request and transmits back an authorization to said payment server;
wherein if said payment server receives said authorization prior to the time that said limited time period expires, said payment server uses said at least one payment source to send said payment amount to said payee.

2. The method of claim 1, wherein at least one payer is a plurality of payers with a number of payers being an integer number greater than one, and said payee communicates to the said payment server said number of said plurality of payers.

3. The method of claim 1, wherein said limited time period is one week or less.

4. The method of claim 1, wherein said payee also transmits at least information pertaining to a time length that said transient transaction ID is to be valid to said payment server; or
wherein said limited time period is a bounded time period with a start time, end time, and therefore also a time length, and said payee also transmits at least information pertaining to the start time and either the end time or time length of said bounded time period to said payment server.

5. The method of claim 1, wherein said payee telecommunications device has a display, and wherein said transient transaction ID is valid only during a limited time period when said transient transaction ID is displayed on said display of said payee telecommunications device.

6. The method of claim 1, wherein said payee telecommunication device provides the transaction ID to the said payer over either a wireless electronic communication channel, by providing an image, or by audio sounds.

7. The method of claim 1, wherein either of said payer or said payee telecommunications device is a computerized device comprising at least one processor, memory, and software.

8. The method of claim 1, wherein said payment server is a web server, and wherein either of said payer or said payee telecommunications device is a computerized device comprising at least one processor, memory, and web browser software; and
at least some of said transaction is conducted using said web browser.

9. The method of claim 1, wherein said transaction ID comprises a numeric or alphanumeric sequence of 10 symbols or less.

10. A transient transaction ID method of payment, comprising:
a payment server connected to a telecommunications network, said payment server comprising at least one processor, memory, and payment software, said payment server being linked to at least one payment source;
at least one payer telecommunications device connected to said telecommunications network;
and at least one payee desiring a payment amount from said payer for a transaction, said payee being connected to said payment server by a payee telecommunications device connected to said telecommunications network;
wherein said payee uses said payee telecommunications device to transmit said payment amount and current location coordinates of said payee telecommunications device to said payment server and requests said payment server generate a transient transaction ID for said transaction;
wherein said transient transaction ID is valid for a limited time period;
said payment server generates said transient transaction ID and transmits said transient transaction ID to said payee;
said payee provides said transient transaction ID to said payer;
said payer uses said payer telecommunications device to transmit said transient transaction ID to said payment server along with the current location coordinates of said payer telecommunications device;
said payment server receives both said payer's transient transaction ID and said current location coordinates of said payers telecommunications device, and upon finding a match between said transient transaction ID provided by said payer, and the transient transaction ID provided by the said payment server to the payee, and upon also finding that said current location coordinates of said payers telecommunications device are within a close proximity of said current location coordinates of said payee telecommunications device, said payment server transmits an authorization request to said payer telecommunications device, said authorization request comprising at least said payment amount, and a request for authorization;
said payer receives said authorization request and transmits back an authorization to said payment server;
wherein if said payment server receives said authorization prior to the time that said limited time period expires, said payment server uses said at least one payment source to send said payment amount to said payee.

11. The method of claim 10, wherein said limited time period is one week or less; or
wherein said payee also transmits at least information pertaining to a time length that said transient transaction ID is to be valid to said payment server; or
wherein said limited time period is a bounded time period with a start time, end time, and therefore also a time length, and said payee also transmits at least information pertaining to the start time and either the end time or time length of said bounded time period to said payment server.

12. The method of claim 10, wherein said payment server persistently stores identification information pertaining to said payee, identification information pertaining to said payer, time of transaction, said payment amount, and said transient transaction ID in a database so that information pertaining to said transaction can be subsequently retrieved for audit purposes.

13. The method of claim 10, wherein said payee is an intermediate server or payment collection server acting as an agent for a primary payee.

14. The method of claim 10, wherein there are a plurality of payment servers, each said plurality of payment servers having its own identifier, and in which said payer also transmits the identity of one of said plurality of payment servers to said payee as an identified payment server, and said payee uses this identity to perform the method of claim 9 with said identified payment server.

15. A transient transaction ID method of payment, comprising:
a payment server connected to a telecommunications network, said payment server comprising at least one processor, memory, and payment software, said payment server being linked to at least one payment source;
at least one payer telecommunications device connected to said telecommunications network;
and at least one payee desiring a payment amount from said payer for a transaction, said payee being connected to said payment server by a payee communications device connected to said telecommunications network;
wherein the said payer provides a Group ID to the said payee
wherein said payee transmits said payment amount and said Group ID to said payment server and requests said payment server generate a transient transaction ID for said transaction;
said transient transaction ID is valid for a limited time period;
said payment server generates said transient transaction ID and transmits said transient transaction ID to said payee;
said payee provides said transient transaction ID to said payer;
said payer transmits said transient transaction ID and the said Group ID to said payment server, using said payer telecommunications device;
said payment server receives said transient transaction ID from said payer and payer's said Group ID, and upon finding a match between the said transient transaction ID and said Group ID provided by said payer and said the transient transaction ID and said Group ID provided by the said payment server to the payee, said payment server transmits an authorization request to said payer telecommunications device, said authorization request comprising at least said payment amount, and a request for authorization;
said payer receives said authorization request and transmits back an authorization to said payment server;
wherein if said payment server receives said authorization prior to the time that said limited time period expires, said payment server uses said at least one payment source to send said payment amount to said payee.

16. The method of claim 15, wherein said payer uses the said payment server to validate that said Group ID is globally unique prior to providing said Group ID to the said payee.

17. The method of claim 15, wherein the said payee provides its GPS coordinates to the said payment server along with the said Group ID.

18. The method of claim 15, wherein said payment server persistently stores identification information pertaining to said payee, identification information pertaining to said payer, time of transaction, said payment amount, and said transient transaction ID in a database so that information pertaining to said transaction can be subsequently retrieved for audit purposes.

19. The method of claim 15, wherein said payee is an intermediate server or payment collection server acting as an agent for a primary payee.

20. The method of claim 15, wherein there are a plurality of payment servers, each said plurality of payment servers having its own identifier, and in which said payer also transmits the identity of one of said plurality of payment servers to said payee as an identified payment server, and said payee uses this identity to perform the method of claim 14 with said identified payment server.

21. The method of claim 15, wherein said limited time period is one week or less; or
wherein said payee also transmits at least information pertaining to a time length that said transient transaction ID is to be valid to said payment server; or
wherein said limited time period is a bounded time period with a start time, end time, and therefore also a time length, and said payee also transmits at least information pertaining to the start time and either the end time or time length of said bounded time period to said payment server.
